(19) United States
(12) Patent Application Publication
(10) Pub. No.: US 2001/0005245 A1
(43) Pub. Date: Jun. 28, 2001

(54) Color liquid crystal display and method of manufacturing color liquid crystal display

(75) Inventors: Michiaki Sakamoto, Tokyo (JP); Yuji Yamamoto, Tokyo (JP); Mamoru Okamoto, Tokyo (JP)

Correspondence Address: Norman P. Soloway, HAYES, SOLOWAY, HENNESSEY, GROSSMAN & HAGE, P.C., 175 Canal Street, Manchester, NH, 03101, US

(73) Assignee: NEC Corporation

(21) Appl. No.: 09/747,062

(22) Filed: Dec. 20, 2000

(30) Foreign Application Priority Data
Dec. 24, 1999 (JP) 368304/1999

(51) Int. Cl. G02F 1/136; G02F 1/1335

(52) U.S. Cl. 349/106; 349/44

(57) ABSTRACT

In a color liquid crystal display, a shading film including a first filter formed from a red resist film, a second filter formed from a blue resist film laminated on the first filter and a third filter formed from a green resist film laminated on the first filter and the second filter is formed on a TFT substrate. Therefore, increment of an optical leak in the TFT is restricted when the shading film is formed by laminating plural filters to be a color filter.

The present application claims priority of Japanese Patent Application No. Hei 11-368304 filed on Dec. 24, 1999, which is hereby incorporated by reference.

### BACKGROUND OF THE INVENTION

1. Field of the Invention

The present invention relates to a color liquid crystal display and a method of manufacturing the color liquid crystal display and more particularly to a color liquid crystal display and a method of manufacturing the color liquid crystal display in which a color filter and a shading film are formed in a TFT (Thin Film Transistor) substrate.

2. Description of the Related Art

A color liquid crystal display is generally used as a display for various information apparatuses or a like.

FIG. 7 is a cross-sectional view showing a schematic configuration of a conventional color liquid crystal display. The color liquid crystal display, as shown in FIG. 7, is provided with a TFT substrate 101 in which a TFT operating as a switching element (driving element) for driving a liquid crystal 103 is formed, an opposite substrate 102 and the liquid crystal 103 held between the TFT substrate 101 and the opposite substrate 102.

The TFT substrate 101, as shown in FIG. 7, is provided with a transparent insulating substrate 104, a gate electrode 105 formed from AL (aluminum), Mo (molybdenum), Cr (chromium) or a like on the transparent insulating substrate 104, a gate insulating film 106 formed from Si₃N₄ (silicon nitride) or a like on the gate electrode 105, a semiconductor film 107 formed from amorphous silicon or a like on the gate insulating film 106 over the gate electrode 105, a source electrode 108 and a drain electrode 109 respectively led from both sides of the semiconductor film 107 and formed from Mo, Cr or a like, and a pixel electrode 115 connected to the drain electrode 109 and formed from ITO (Indium Tin Oxide) or a like. A TFT 110 is provided with the gate electrode 105, the gate insulating film 106, a semiconductor film 107, the source electrode 108 and the drain electrode 109.

The opposite substrate 102 is provided with a transparent insulating substrate 118 formed from glass or a like, a black matrix 119 formed at an opposite side of the TFT 110 as a shading film used to prevent a light from going into the TFT 110 or to shade a light from going into an unrelated part for display, a color filter 121 including a red filter 121R, a green filter 121G and a blue filter 121B which are respectively formed at opposite sides of the pixel electrodes 115 in the TFT substrate 101, a flatting film (overcoat film) 122 covering the red filter 121R, the green filter 121G and the blue filter 121B and a common opposite electrode 123 covering the flatting film 122 and formed from ITO or the like. The flatting film 122 is provided in order to prevent a harmless material such as ion from mixing with the liquid crystal 103 via the red filter 121R, the green filter 121G, the blue filter 121B or a like, and to so as to flatten the substrates of these filters 121R, 121G, 121B.

The above-mentioned conventional color liquid crystal display has an advantage in a manufacturing process since the black matrix 119, the red filter 121R, the green filter 121G and the blue filter 121B are formed in the opposite substrate 102 in which no TFT 110 is formed. However, it is necessary to adjust the black matrix 119, the red filter 121R, the green filter 121G and the blue filter 121B in the opposite substrate 102 so as to be arranged at predetermined positions to the TFT substrate 101 when the color liquid crystal display is assembled by putting the liquid crystal 103 between the TFT substrate 101 and the opposite substrate 102. Thus, it is necessary to keep a margin while considering a difference between the TFT substrate 101 and the opposite substrate 102, and therefore, an pixel aperture ratio becomes small for the margin. As a result, it is impossible to avoid a luminance deterioration.

Thus, in order to avoid a deterioration of the pixel aperture ratio, another color liquid crystal display shown in FIG. 8 is provided in which a black matrix 112 and a color filter are formed in the TFT substrate 101.

The other conventional liquid crystal display, as shown in FIG. 8, is provided with the TFT substrate 101 in which a TFT operating as a switching element for driving a liquid crystal 103, an opposite substrate 102 and the liquid crystal 103 held between the TFT substrate 101 and the opposite substrate 102.

The TFT substrate 101, as shown in FIG. 8, is provided with a transparent insulating substrate 104 formed from glass or a like, a gate electrode 105 formed from AL, Mo, Cr or a like on the transparent insulating substrate 104, a gate insulating film 106 formed from Si₃N₄ or a like on the gate electrode 105, a semiconductor film 107 formed from amorphous silicon or a like on the gate insulating film 106 over the gate electrode 105, a source electrode 108 and a drain electrode 109 respectively led from both sides of the semiconductor film 107 and formed from Mo, Cr or a like, and an insulating protective film 111 covering the source electrode 108, the semiconductor film 107 and the drain electrode 109 and formed from Si₃N₄ or a like. A TFT 110 is provided with the gate electrode 105, the gate insulating film 106, the semiconductor film 107, the source electrode 108 and the drain electrode 109.

Further, the TFT substrate 101 is provided with the black matrix 112 formed on the insulating protective film 111 as a shading film used to prevent a light from going into the TFT 110 or to shade a light from going into an unrelated part for display, the color filter including a red filter 113R, a green filter 113G and a blue filter 113B (only the red filter 113R is shown) which are respectively formed on the insulating protective film 111, a flatting film (overcoat film) 114 covering the black matrix 112 and the color filter 113 and formed from photosensitive resist and a pixel electrode 115 formed so as to be connected to the drain electrode 109 on the flatting film 114 and formed from ITO or the like.

With the conventional color liquid crystal display as shown in FIG. 8, it is unnecessary to keep the margin for the difference between the TFT substrate 101 and the opposite substrate 102 when the liquid crystal display is manufactured by putting the liquid crystal 103 between the TFT substrate 101 and the opposite substrate 102 as shown in FIG. 7, since the black matrix 112 and the color filter 113 (the red filter 113R, the green filter 113G and the blue filter 113B) are formed in the TFT substrate 101 having the TFT 110. As a result, it is possible to increase a pixel aperture ratio and to avoid a luminance deterioration, and therefore, it is possible to produce a bright display.

FIG. 11 is a graph showing a relationship between a number of pixels, namely, a PPI (Pixel Per Inch) and a PAR (Pixel Aperture Ratio) in the conventional liquid crystal display shown in FIG. 7 and the conventional liquid crystal display shown in FIG. 8. A characteristic “A” shows a relationship in the conventional liquid crystal display shown in FIG. 7. A characteristic B shows a relationship in the conventional liquid crystal display shown in FIG. 8. As understood from FIG. 9, the conventional liquid crystal display shown in FIG. 8 in which the black matrix 112 and the color filter are formed in the TFT substrate 101 can keep the PAR larger than the conventional liquid crystal display shown in FIG. 7 in which the black matrix 119 and the color filter 121 are formed in the opposite substrate 102.

Next, explanations will be given of a method of manufacturing the color liquid crystal display shown in FIG. 8 in order of processes with reference to FIG. 10A to FIG. 10F.

First, as shown in FIG. 10A, a conductive film having a thickness of 100 nm to 300 nm and formed from Al, Mo, Cr or a like is formed on a whole upper surface of the transparent insulating substrate 104 formed from glass or a like using a sputtering technique, and then the gate electrode 105 is formed by patterning the conductive film using a known lithography technique. Then, the gate insulating film 106 having a thickness of 200 nm to 400 nm and formed from Si₃N₄ or a like is formed over the whole upper surface of the transparent insulating substrate 104 using a CVD (Chemical Vapor Deposition) technique.

Next, as shown in FIG. 10B, a semiconductor film having a thickness of 100 nm to 400 nm and formed from amorphous silicon or a like is formed over the whole upper surface of the transparent insulating substrate 104 using the CVD technique is formed, and then the semiconductor film 107 is formed by patterning the semiconductor film using the lithography technique. Then, a conductive film having a thickness of 100 nm to 300 nm and formed from Al, Mo, Cr or a like is formed over the whole upper surface of the transparent insulating substrate 104 using the sputtering technique, and then the source electrode 108 and the drain electrode 109 are formed by patterning the conductive film using the lithography technique. Then, the insulating protective film 111 having a thickness of 200 nm to 400 nm and formed from Si₃N₄ or a like is formed over the whole upper surface using the CVD technique.

With these processes, the TFT 110 is formed in which the gate electrode 105, the gate insulating film 106, the semiconductor film 107, the source electrode 108 and the drain electrode 109 are formed on the transparent insulating substrate 104.

Next, as shown in FIG. 10C, a black resist film in which black pigments are dispersed to acrylic photosensitive resist or a like is coated over the whole upper surface of the transparent insulating substrate 104 using a spin coating technique, and then the black matrix 112 having a thickness of 1.2 μm to 1.5 μm is formed so as to cover the upper surface of the TFT 110 by patterning the black resist film using the lithography technique.

Then, as shown in FIG. 10D, a red resist film in which red pigments are dispersed within an acrylic photosensitive resist or a like is coated over the whole upper surface using the spin coating technique, and then a red filter 113R having a thickness of 1.0 μm to 1.2 μm is formed at pixel positions for red cells by patterning the red resist film using the lithography technique. Similarly, a green resist film in which green pigments are dispersed within an acrylic photosensitive resist or a like is coated over the whole upper surface using the spin coating technique, and then a green filter 113G (not shown) having a thickness of 1.0 μm to 1.2 μm is formed at pixel positions for green cells by patterning the green resist film using the lithography technique. Also, a blue resist film in which blue pigments are dispersed within an acrylic photosensitive resist or a like is coated over the whole upper surface using the spin coating technique, and then a blue filter 113B (not shown) having a thickness of 1.0 μm to 1.2 μm is formed at pixel positions for red cells by patterning the blue resist film using the lithography technique. With these processes, the color filter (a red filter 113R is shown in FIG. 10D) is formed on the insulating protective film 111.

Then, as shown in FIG. 10E, a positive acrylic photosensitive resist film having a thickness of 2 μm to 3 μm is coated over the whole upper surface using the spin coating technique, and then the flatting film 114 making a part of the insulating protective film 111 exposed is formed. Then, the contact hole 116 exposing the drain electrode 109 to the insulating protective film 111 is selectively formed.

Then, as shown in FIG. 10F, a conductive film formed from ITO or a like is formed over the whole upper surface including the contact hole 116, and then the pixel electrode 115 having a thickness of 80 nm to 100 nm by patterning the conductive film using a photolithography technique. With these processes, TFT substrate 101 (FIG. 8) is formed.

Next, the liquid crystal 103 is put between the TFT substrate 101 and the opposite substrate 102 obtained by the above-mentioned processes, and thereby the color liquid crystal display shown in FIG. 8 is made.

Now, the above-mentioned method of manufacturing the color liquid crystal display has a disadvantage in that a number of processes increases and increment of a cost can not be avoided, since the black matrix 112 is formed in the process separated from the forming process for the color filter 113. Also, a negative photosensitive resist film is usually used as the black matrix 112, however, a light hardly passes through the negative photosensitive resist. Thus, though an amount of exposure is increased, a photo-cross-link occurs only at the surface, therefore, a defect often occurs in which the black matrix 112 comes off during manufacture.

For example, Japanese Patent Application Laid-open No. Sho 62-250416 discloses a color liquid crystal display in which a black matrix 112 and a color filter are formed in a same forming process. The color liquid crystal display, as shown in FIG. 11, on a surface of a TFT 110R for a red cell to form a red filter 113R, a green filter 113G and a blue filter 113B are successively formed so as to be laminated. On a surface of the TFT 110G for a green cell to form the green filter 113G, the blue filter 113B and the red filter 113R are successively formed so as to be laminated. On a surface of the TFT 110B for the blue cell to form the blue filter 113B, the red filter 113R and the green filter 113G are successively formed so as to be laminated. Other parts are similar to those in FIG. 8, therefore, same numeral numbers are applied to those in FIG. 11 and explanations are omitted.

In the above-mentioned color liquid crystal display, since the black matrix 112 formed by laminating three layers, namely, the red filter 113R, the green filter 113G and the blue filter 113B, on all the TFT 110R for the red cell, the TFT 110G for the green cell and the TFT 110B for the blue cell, it is possible to form the black matrix 112 at a same time of forming the color filter 113.

However, the conventional color liquid crystal display has a problem in that an optical leak of a TFT increases since a black matrix is formed by merely laminating a red filter, a green filter, and blue filter.

In other words, when the black matrix is formed by laminating the red filter, the green filter, and the blue filter, each of the red filter, the green filter, and the blue filter is formed by coating each color resist film using a spin coating technique and then by executing a known photolithography technique including an exposure process, a developing process, a burning process, and a like. The present inventor found that a third layer color filter (such as a blue filter) is much thinner than a first layer color filter (such as a red filter) at each filter-laminated part. As a result, since shading of the TFT becomes insufficient caused by an order of forming each filter or a thickness of each filter, it is possible to avoid increment of the optical leak.

FIG. 12 is a graph showing a relationship between a wavelength λ (horizontal axis) of amorphous silicon forming the TFT formed on a TFT substrate and a QE (Quantum Efficiency) (vertical axis). FIG. 12 shows that a sensitivity is high to an amorphous silicon concerning a wavelength of a large QE, and a current flows easily. Therefore, understood from FIG. 12, a wavelength from 500 nm to 650 nm has highest sensitivity and wavelength in this range becomes green. That is, concerning the TFT formed from the amorphous silicon, the optical leak increases extremely when the green light is illuminated. However, concerning blue light in a range of short wavelengths and red light in a range of long wavelengths, QE is smaller than that of the green light, therefore, though the blue light or the red light is illuminated to the TFT, increment of the optical leak is reduced more than the green light.

As described above, though the black matrix is formed by merely laminating the red filter, the green filter and the blue filter as the conventional color liquid crystal display, in a case in that the black matrix is formed so as to receive a large quantity of the green light, increment of the optical leak can not avoided. As undesirable configurations, there is a configuration in which the green filter is formed directly on the TFT, and a configuration in which a thickness of the green filter is thick not formed directly on the TFT, and a like.

### SUMMARY OF THE INVENTION

In view of the above, it is an object of the present invention to provide a color liquid crystal display and a method of manufacturing the color liquid crystal display capable of reducing increment of an optical leak in a TFT when a shading film is formed by laminating plural filters to be a color filter.

According to a first aspect of the present invention, there is provided a color liquid crystal display in which a liquid crystal is put between a TFT substrate and an opposite substrate, the color liquid crystal display including:

a shading film including a first filter formed from one of a red resist film and a blue resist film and a second filter formed from another of the red resist film and the blue resist film and laminated on the first filter and being formed in the TFT substrate; and

a color filter including the red resist film and the blue resist film.

Also, according to a second aspect of the present invention, there is provided a color liquid crystal display in which a liquid crystal is put between a TFT substrate and an opposite substrate, the color liquid crystal display including:

a shading film including a first filter formed from one of a red resist film and a blue resist film, a second filter formed from another of the red resist film and the blue resist film and laminated on the first filter and a third filter formed from a green resist film and laminated on the second filter over the first filter and being formed in the TFT substrate; and

a color filter including the red resist film, the blue resist film and the green resist film.

In context with the foregoing, a preferable mode is one wherein the shading film is formed to cover a surface of a liquid crystal driving element formed in the TFT substrate.

Another preferable mode is one wherein the third filter is thinnest among the first filter, the second filter and the third filter forming the shading film.

A further preferable mode is one wherein the first filter, the second filter and the third filter are formed from pigment-dispersed photosensitive resist.

According to a third aspect of the present invention, there is provided a method of manufacturing a color liquid crystal display in which a liquid crystal is put between a TFT substrate and an opposite substrate and a color filter and a shading film including plural unit filters are laminated on the TFT substrate; the method including;

a step of forming plural liquid crystal driving elements on the TFT substrate;

a step of sequentially forming the plural unit filters on surfaces of the liquid crystal driving elements; and

a step of forming a green filter at last.

Furthermore, according to a fourth aspect of the present invention, there is provided a method of manufacturing a color liquid crystal display in which a liquid crystal is put between a TFT substrate and an opposite substrate and a color filter and a shading film including plural unit filters are laminated on the TFT substrate; the method including;

a liquid crystal driving element forming step of forming plural liquid crystal driving elements on the TFT substrate;

a first filter forming step of forming a first filter formed from one of a red filter and a blue filter on an insulating protective film after covering the liquid crystal driving elements with the insulating protective film;

a first patterning step of patterning the first filter so as to be left at a first pixel position and surfaces of the liquid crystal driving elements;

a second filter forming step of forming a second filter formed from another of the red filter and the blue filter on a whole surface including the first filter;

a second patterning step of patterning the second filter so as to be left at a second pixel position and on the first filter;

a third filter forming step of forming a third filter formed from a green filter on a whole surface including the first filter and the second filter; and

a third patterning step of patterning the third filter so as to be left at a third pixel position and on the second filter.

In context with the foregoing, a preferable mode is one further including:

a flatting film through hole forming step of forming a flatting film on a whole surface including the third filter and of forming a through hole making an electrode of the liquid crystal driving element exposed by patterning the flatting film successively in the third patterning step.

Another preferable mode is one further including:

a pixel electrode forming step of forming a pixel electrode for connecting the through hole to the electrode successively in the flatting film through hole forming step.

A further preferable mode is one wherein as the red filter, the blue filter and the green filter; red-pigment dispersed photosensitive resist, blue-pigment dispersed photosensitive resist, green-pigment dispersed photosensitive resist are respectively used.

With the above configurations, a shading film including a first filter which is a red resist film or a blue resist film, a second filter which is a red resist film laminated on the first filter and a third filter which is a green resist film laminated on the first filter and the second filter is formed, therefore, it is possible to shade a green light of a wavelength having a largest QE.

Also, with this method, it is possible to form a shading film at a same time of a process of forming a red filter, a blue filter and a green filter, therefore, it is possible to avoid increment of a cost since a number of processes of forming the shading film does not increase.

Therefore, it is possible to restrict increment of an optical leak in the TFT when the shading film is formed by laminating plural filters to be a color filter.

### BRIEF DESCRIPTION OF THE DRAWINGS

The above and other objects, advantages, and features of the present invention will be more apparent from the following description taken in conjunction with the accompanying drawings in which:

FIG. 1 is a plan view showing a configuration of a color liquid crystal display according to a first embodiment of the present invention;

FIG. 2 is a cross-sectional view showing a part indicated by arrows A in FIG. 1;

FIG. 3A to FIG. 3C are schematic views showing processes of forming a main part of the color liquid crystal display according to the first embodiment of the present invention;

FIG. 4 is a graph showing a relationship between an applied voltage to a TFT (horizontal axis) and a leak current (vertical axis) in the color liquid crystal display according to the first embodiment and a second embodiment of the present invention;

FIG. 5A, FIG. 5B and FIG. 5C are process views showing a method of the manufacturing color liquid crystal display in an order of processes according to the first embodiment of the present invention;

FIG. 5D, FIG. 5E and FIG. 5F are process views showing the method of manufacturing the color liquid crystal display in the order of processes according to the first embodiment of the present invention;

FIG. 5G and FIG. 5H are process views showing the method of manufacturing the color liquid crystal display in the order of processes according to the first embodiment of the present invention;

FIG. 6 is a cross-sectional view showing a configuration of a color liquid crystal display according to the second embodiment of the present invention;

FIG. 7 is a cross-sectional view showing a configuration of a conventional color liquid crystal display;

FIG. 8 is a cross-sectional view showing a configuration of another conventional color liquid crystal display;

FIG. 9 is a graph showing a relationship between a PPI (Pixel Per Inch) (horizontal axis) and a PAR (Pixel Aperture Ratio) (vertical axis) in the conventional color liquid crystal display;

FIG. 10A, FIG. 10B and FIG. 10C are process views showing a conventional method of manufacturing the conventional color liquid crystal display in an order of processes;

FIG. 10D, FIG. 10E and FIG. 10F are process views showing the conventional method of manufacturing the conventional color liquid crystal display in the order of processes;

FIG. 11 is a cross-sectional view showing a configuration of the conventional color liquid crystal display; and

FIG. 12 is a graph showing a relationship between a wavelength λ (horizontal axis) and a QE (Quantum Efficiency) of amorphous silicon forming a TFT in the conventional color liquid crystal display.

### DETAILED DESCRIPTION OF THE PREFERRED EMBODIMENTS

Best modes for carrying out the present invention will be described in further detail using various embodiments with reference to the accompanying drawings.

### First Embodiment

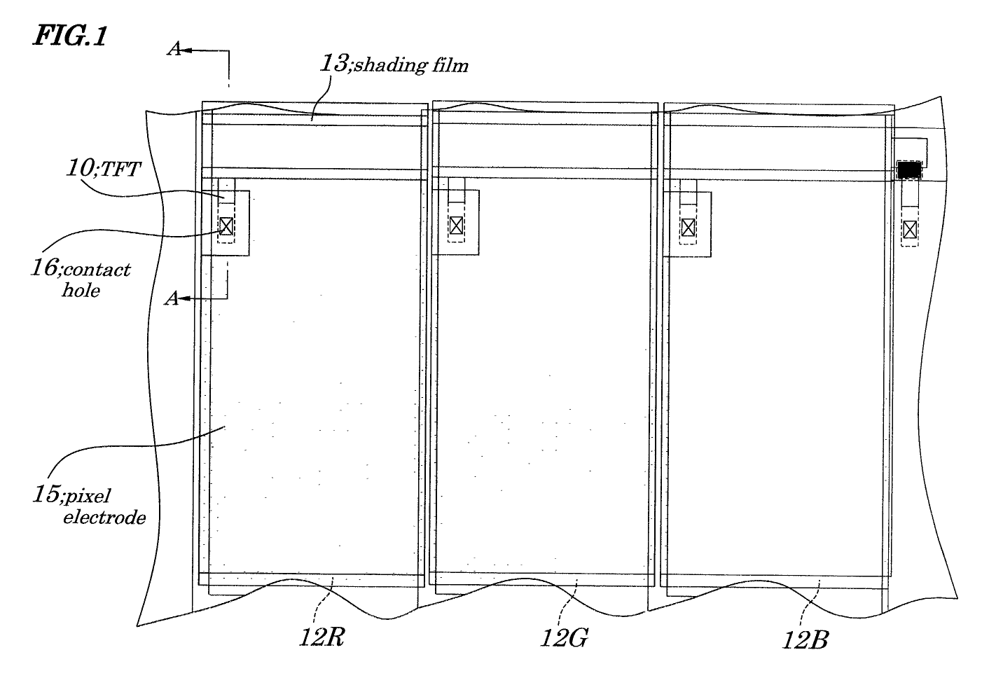

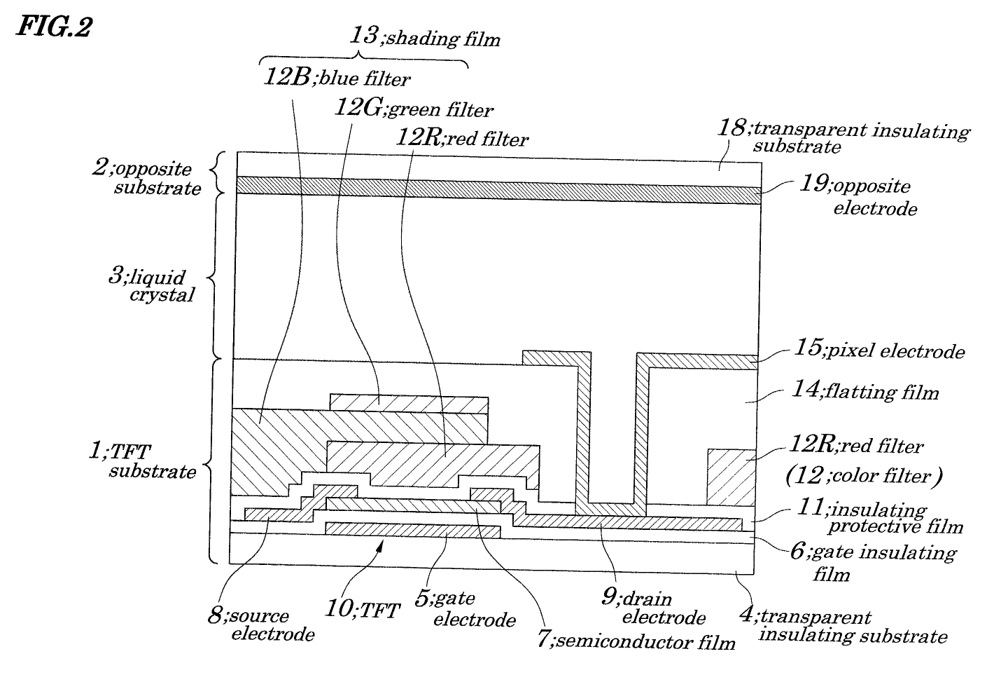

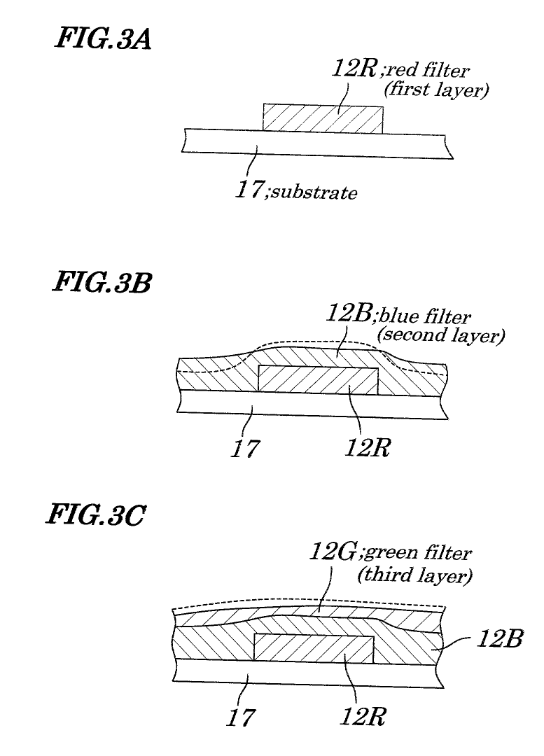

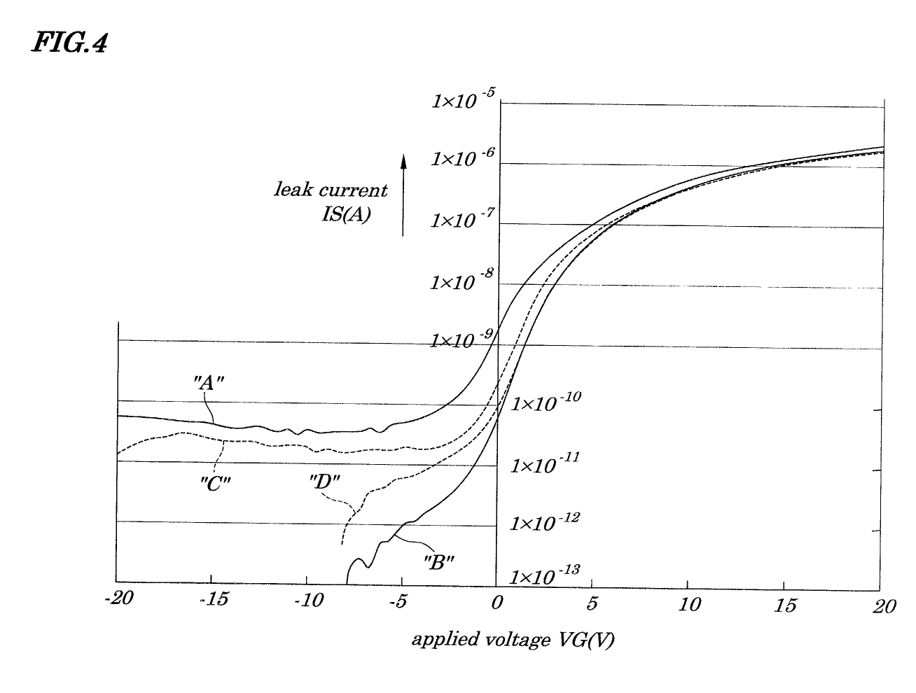

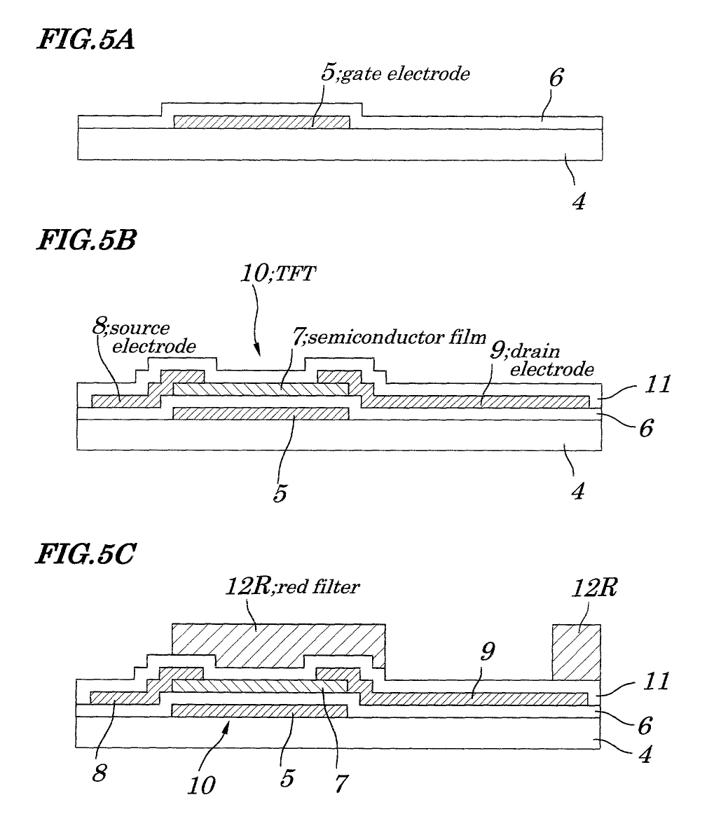

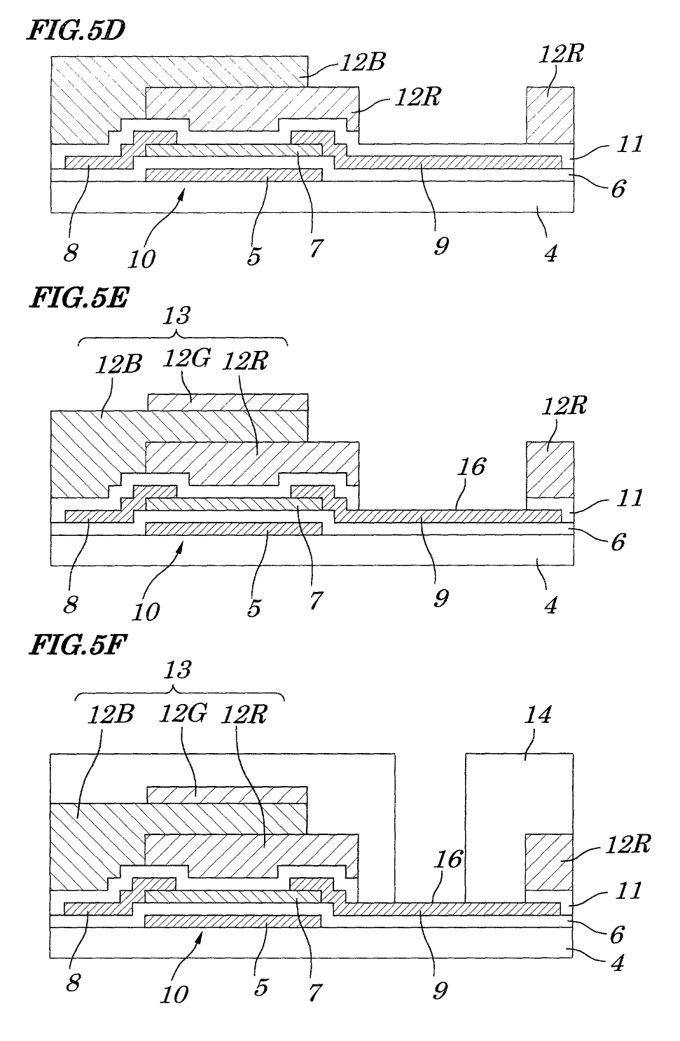

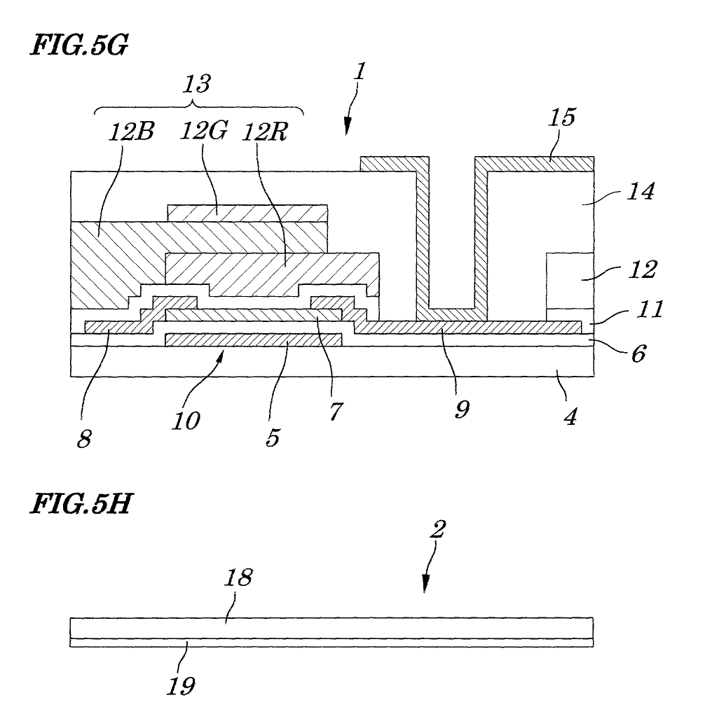

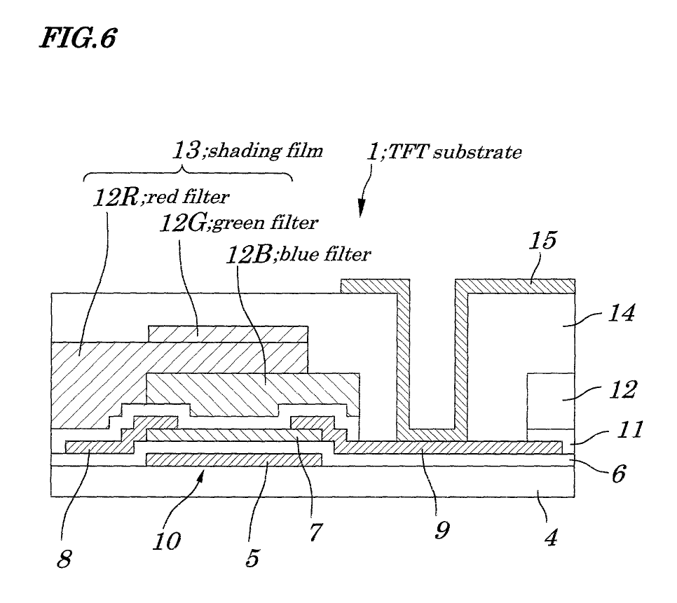

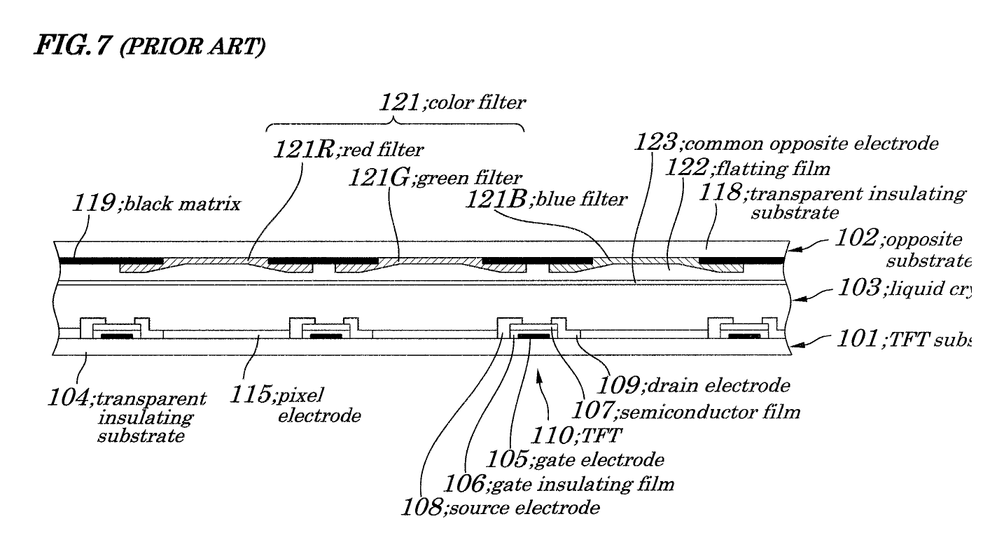

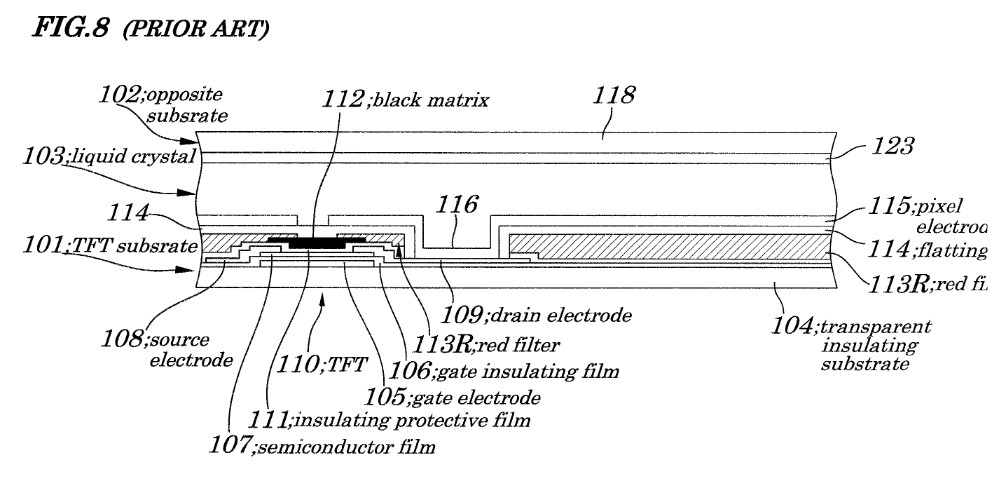

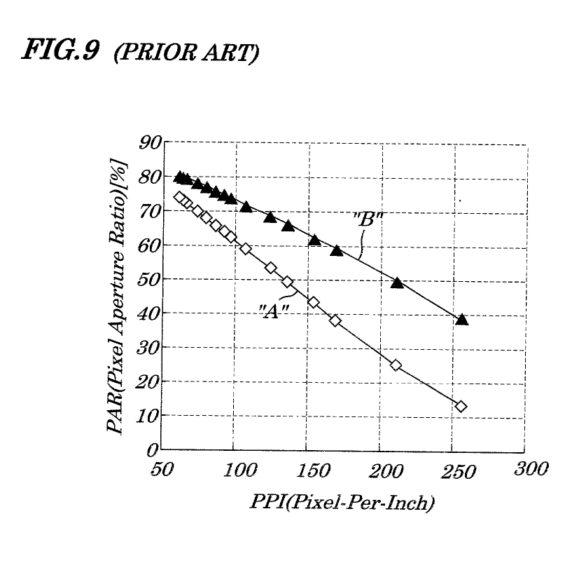

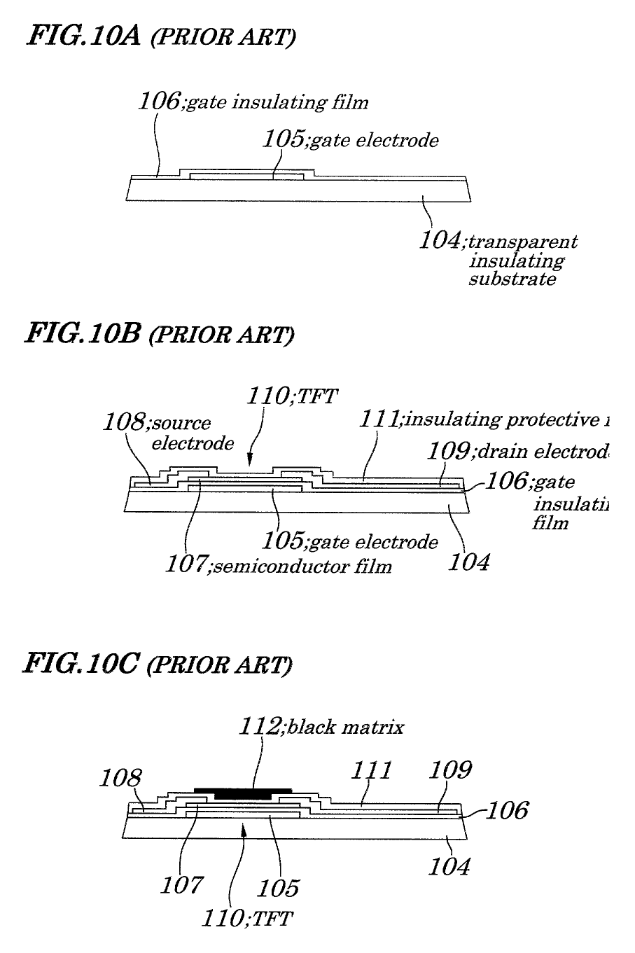

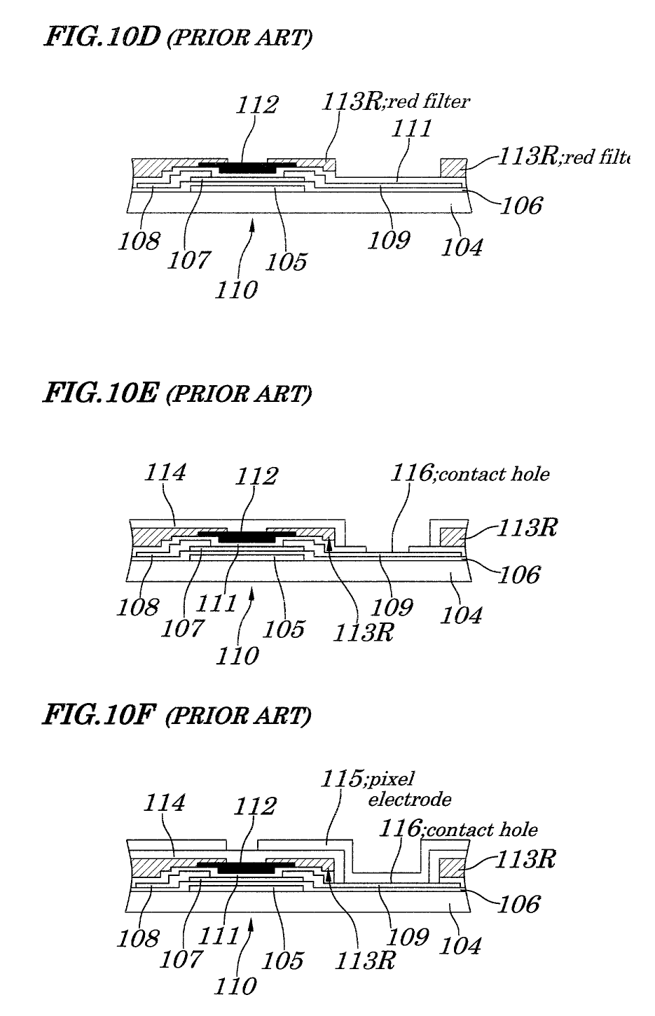

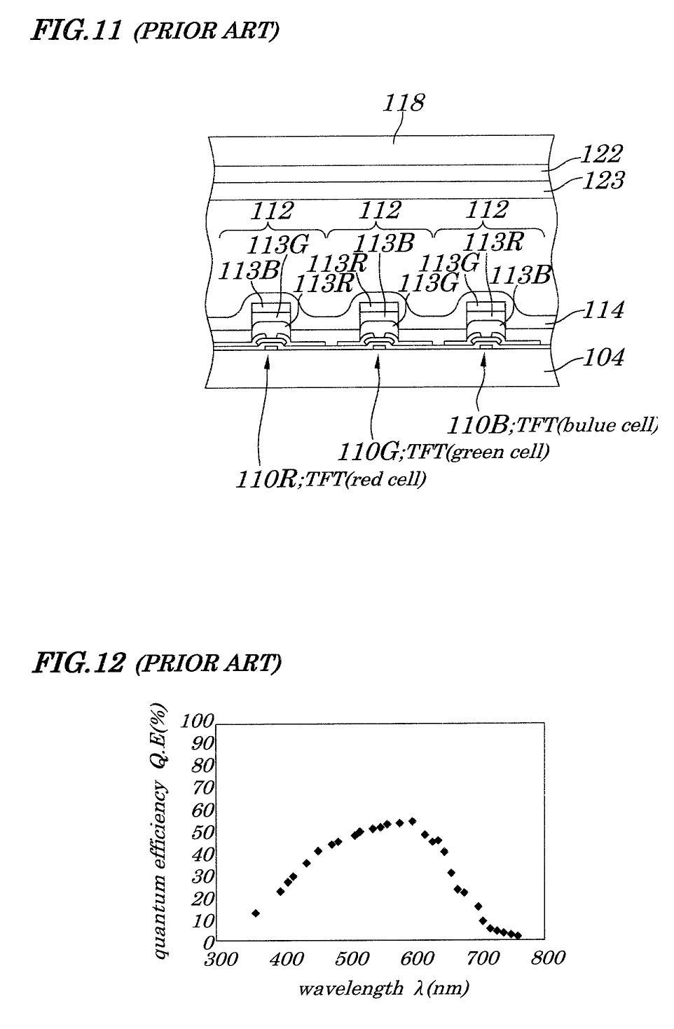

FIG. 1 is a plan view showing a configuration of a color liquid crystal display according to a first embodiment of the present invention, FIG. 2 is a cross-sectional view showing a part indicated by arrows A in FIG. 1, FIG. 3A to FIG. 3C are schematic views showing processes of forming a main part of the color liquid crystal display, FIG. 4 is a graph showing a relationship between an applied voltage to a TFT (horizontal axis) and a leak current (vertical axis) in the color liquid crystal display and FIG. 5A to FIG. 5H are process views showing a method of manufacturing the color liquid crystal display in an order of processes.

The color liquid crystal display, as shown in FIG. 2, is provided with a TFT substrate 1 including a TFT 10 operating as a switching element for driving a liquid crystal 3, an opposite substrate 2 and the liquid crystal 3 put between the TFT substrate 1 and the opposite substrate 2.

The TFT substrate 1 is provided with a transparent insulating substrate 4 formed from glass or a like, a gate electrode 5 having a thickness of 100 nm to 300 nm and formed from AL (aluminum), Mo (molybdenum), Cr (chromium) or a like on the transparent insulating substrate 4, a gate insulating film 6 having a thickness of 200 nm to 400 nm and formed from Si₃N₄ (silicon nitride) or a like on the gate electrode 5, a semiconductor film 7 having a thickness of 100 nm to 400 nm and formed from amorphous silicon or a like on the gate insulating film 6 over the gate electrode 5, a source electrode 8 and a drain electrode 9 having respective thickness of 100 nm to 300 nm, respectively led from both sides of the semiconductor film 7 and formed from Mo, Cr or a like and an insulating protective film 11 having a thickness of 200 nm to 400 nm and formed from Si₃N₄ to cover the source electrode 8 and the drain electrode 9. The TFT 10 is provided with the gate electrode 5, the gate insulating film 6, the semiconductor film 7, the source electrode 8 and the drain electrode 9.

Further, the TFT substrate 1 is provided with a color filter 12 including a red filter 12R, a green filter 12G and a blue filter 12B, each of which has a thickness of 1.4 μm to 1.6 μm, on the insulating protective film 11, a shading film 13 formed on the insulating protective film 11 and used to prevent a light from going into the TFT 10 or to shade the light going into an unrelated part for display, a flatting film 14 covering the color filter 12 and the shading film 13, formed from photosensitive resist or a like and having a thickness of 2.0 μm to 4.0 μm and a pixel electrode 15 formed so as to be connected to the drain electrode 9 on the flatting film 14, formed from ITO or a like and having a thickness of 50 nm to 100 nm.

The opposite substrate 2 is provided with a transparent insulating substrate 18 formed from glass or a like and a common opposite electrode 19 formed from ITO or the like.

In the first embodiment, the shading film 13 covering a surface of the TFT 10 is formed by laminating the red filter 12R of a first layer, the blue filter 12B of a second layer and the green filter 12G of a third layer. Therefore, though each of the red filter 12R, the green filter 12G and the blue filter 12B has the thickness of 1.4 μm to 1.6 μm as described above, a laminated part has a thickness described as follows.

That is, the red filter 12R of the first layer consists essentially of a red resist film having a thickness of 1.4 μm to 1.6 μm, in which red pigments are dispersed within an acrylic photosensitive resist. The blue filter 12B of the second layer consists essentially of a blue resist film having a thickness of 0.9 μm to 1.1 μm, in which blue pigments are dispersed within an acrylic photosensitive resist. The green filter 12G of the third layer consists essentially of a green resist film having a thickness of 0.3 μm to 0.5 μm, in which green pigments are dispersed within an acrylic photosensitive resist. Each of the red resist film 12R, the blue resist film 12B and the green resist film 12G is coated by a spin coating technique as described later; and a later coated resist, the thinner.

FIG. 3A to FIG. 3C are schematic view showing a method of forming the red filter 12R, the blue filter 12B and the green filter 12G by sequentially coating the red resist film, the blue resist film and the green resist film.

First, as shown in FIG. 3A, the red resist film having a thickness of 1.4 μm to 1.6 μm is coated on a whole surface of a substrate 17 using the spin coating technique, and then the red filter (first layer) having a same thickness is formed by patterning using a lithography technique.

Then, as shown in FIG. 3B, the blue resist film having a thickness approximately similar to that of the red resist film is coated on the whole surface using the spin coating technique as indicated by a dotted line. However, a part of the blue resist film flows out around caused by spin and the blue resist film becomes thinner, and then the blue filter (second layer) having a thickness of 0.9 μm to 1.6 μm is formed on the red filter 12R.

Then, as shown in FIG. 3C, the green resist film having a thickness approximately similar to that of the red resist film is coated on the whole surface using the spin coating technique as indicated by a dotted line. However, the most of the blue resist film flows out around caused by spin and the green resist film becomes much thinner, and then the green filter (third layer) having a thickness of 0.3 μm to 0.5 μm is formed on the blue filter 12B over the red filter 12R. In other words, the green filter 12G of the third layer is thinner than the red filter 12R of the first layer and the blue filter 12G of the second layer by a layer difference at the laminated part.

As described above, according to the first embodiment, the shading film 13 is formed by laminating the red filter 12R, the blue filter 12B and the green filter 12G in order and thereby the green filter 12G causing increment of the optical leak of the TFT 10 is formed at a position so as to be most separated from the TFT 10 and so as to be thinnest, therefore, it is possible to reduce the increment of the optical leak in the TFT 10.

FIG. 4 is a graph showing a relationship between an applied voltage VG (horizontal axis) and a leak current IS (vertical axis) of the TFT 10 on the TFT substrate 1 in which the shading film 13 is formed according to the first embodiment. A characteristic “A” represents a characteristic after irradiating and a characteristic “B” represent a characteristic before irradiating. As understood from FIG. 4, though the leak current increases after irradiating than before irradiating, the leak current is relatively restricted.

Next, explanations will be given of the method of manufacturing the color liquid crystal display in order of process with reference to FIG. 5A to FIG. 5H.

First, as shown in FIG. 5A, a conductive film formed from Al, Mo, Cr or a like is formed using a sputtering technique on the transparent insulating substrate 4 formed from glass or a like, and then the gate electrode 5 having a thickness of 100 nm to 300 nm is formed by patterning the conductive film using the known lithography technique. Then, the gate insulating film 6 having a thickness of 200 nm to 400 nm and formed from Si₃N₄ or a like is formed on the whole surface of the transparent insulating film 4 using a CVD (Chemical Vapor Deposition) technique. Then, as shown in FIG. 5B, a semiconductor film formed from amorphous silicon or a like is formed on the whole surface of the gate insulating film 6 using the CVD technique, and then the semiconductor film 7 having a thickness of 100 nm to 400 nm is formed by patterning the semiconductor film using the lithography technique. Then, a conductive film formed from Mo, Cr or a like is formed on the whole surface using the sputtering technique, and then the source electrode 8 and the drain electrode 9 having a thickness of 100 nm to 300 nm are formed by patterning the conductive film using the lithography technique. Then, the insulating protective film 11 having a thickness of 200 nm to 400 nm and formed from Si₃N₄ or a like is formed on the whole surface using the CVD technique.

With these processes, the TFT 10 including the gate electrode 5, the gate insulating film 6, the semiconductor film 7, the source electrode 8 and the drain electrode 9 are formed on the transparent insulating substrate 4.

Next, as shown in FIG. 5C, a red resist film in which red pigments are dispersed within an acrylic photosensitive resist or a like is coated on the whole surface using the spin coating technique, and then the red filter 12R having a thickness of 1.4 μm to 1.6 μm is formed on all the surface of the TFT 10 at all pixel positions for red cells by patterning the red resist film using the lithography technique.

Then, as shown in FIG. 5D, a blue resist film in which blue pigments are dispersed within an acrylic photosensitive resist or a like is coated on the whole surface using the spin coating technique, and then the blue filter 12B is formed on all the red filters 12R of the surface of the TFT 10 at all desirable positions in which the blue filters must be formed by patterning the green resist film using the lithography technique. At this time, the blue filter 12B having a thickness approximately similar to that of the red filter 12R at the desirable position for blue cells, however, the blue filter 12B having a thickness of 0.9 μm to 1.1 μm is formed on the red filter 12R on the surface of the TFT 10 due to a reason explained with reference to FIG. 3A to FIG. 3C.

Then, as shown in FIG. 5E, a green resist film in which green pigments are dispersed within an acrylic photosensitive resist or a like is coated on the whole surface using the spin coating technique, and then the green filter 12G is formed on all the blue filters 12B of the surface of the TFT 10 at all desirable positions in which the green filters must be formed by patterning the green resist film using the lithography technique. At this time, the green filter 12G having a thickness approximately similar to that of the red filter 12R at the desirable position for green cells, however, the green filter 12B having a thickness of 0.3 μm to 0.5 μm is formed on the blue filter 12B on the surface of the TFT 10 due to the reason explained with reference to FIG. 3A to FIG. 3C.

Then, as shown in FIG. 5F, a positive acrylic photosensitive resist film having a thickness of 2 μm to 3 μm is coated on the whole surface using the spin coating technique, and then a flatting film 14 making a part of the insulating protective film 11 on the drain electrode 9 exposed is formed. Then, the contact hole 16 exposing the drain electrode 9 to the insulating protective film 11 is selectively formed.

Next, as shown in FIG. 5G, a conductive film having a thickness of 80 nm to 100 nm and formed from ITO or a like is formed on the whole surface including the contact hole 16, and then the pixel electrode 15 having a thickness of 80 nm to 100 nm by patterning the conductive film using a photolithography technique. With these processes, the TFT substrate 1 is formed.

Then, as shown in FIG. 5H, a conductive film formed from ITO or a like is formed using the transparent insulating substrate 18 formed from glass or a like, and then the opposite electrode 19 is formed. With these processes, the opposite substrate 2 is formed.

Next, the liquid crystal 3 is put between the TFT substrate 1 and the opposite substrate 2 obtained by the above-mentioned processes, and thereby the color liquid crystal display shown in FIG. 1 and FIG. 2 is made.

As described above, according to the color liquid crystal display of the first embodiment, the shading film 13 includes a first filter which is the red filter 12R, a second filter which is the blue filter 12B laminated on the first filter and a third filter which is the green filter 12G laminated on the first filter and the second filter, therefore, it is possible to shade green wavelength light having the largest QE.

Also, according to the color liquid crystal display of the first embodiment, it is possible to form the shading film 13 at a same process as the red filter 12R, the blue filter 12B and the green filter 12G, therefore, it is possible to avoid increment of a cost since a number of processes for forming a shading film does not increase.

Therefore, it is possible to restrict increment of the optical leak of the TFT when the shading film is formed by laminating plural filters to be a color filter.

### Second Embodiment

Further, a second embodiment according to the present invention will be described.

FIG. 6 is a cross-sectional view showing a configuration of a color liquid crystal display according to the second embodiment of the present invention. A difference between configuration of the first embodiment and that of the second embodiment is that an order of laminating a red filter and a blue filter to be a shading film is changed.

That is, in the second embodiment, as shown in FIG. 6, a blue filter 12B of a first layer is a blue resist film having a thickness of 1.4 μm to 1.6 μm, in which blue pigments are dispersed within an acrylic photosensitive resist or a like, a red filter 12R of a second layer is a red resist film having a thickness of 0.9 μ m to 1.1 μm, in which red pigments are dispersed within an acrylic photosensitive resist or a like and a green filter 12G of a third layer is a green resist film having a thickness of 0.3 μm to 0.5 μm, in which green pigments are dispersed within an acrylic photosensitive resist or a like.

In FIG. 4, a characteristic “C” represents a characteristic after irradiating and a characteristic “D” represents a characteristic before irradiating. As understood from FIG. 4, the leak current increases after irradiating than before irradiating, however, the leak current is relatively restricted and it is possible to obtain same effects as the first embodiment.

The second embodiment is similar to the first embodiment except for order of laminating. Thus, in FIG. 6, same numerals are given to parts corresponding to those in FIG. 1 and FIG. 2 and explanations thereof are omitted.

As described above, according to the second embodiment, it is possible to obtain effects approximately similar to effects of the first embodiment.

It is thus apparent that the present invention is not limited to the above embodiments but may be changed and modified without departing from the scope and spirit of the invention.

For example, it is unnecessary to use three filters, namely, a red filter, a blue filter and a green filter to form a shading film formed by laminating plural filters to be a color filter, and at least two filters, namely, a red filter and a blue filter may be laminated. Also, a TFT is used as a switching element for driving a liquid crystal in these embodiments, however, the present invention is not limited to this, another switching element such as a diode may be used.

Also, in these embodiments, a transparent insulating substrate is used as a TFT substrate and a switching element is formed on a semiconductor film formed on the transparent insulating substrate, however, the present invention is not limited to this, another substrate such as a semiconductor substrate, for example, a silicon substrate may be used and a switching element may be formed on this substrate. Also, conditions such as various insulating films, processes of forming a conductive film, a film thickness and a like are examples, and these conditions may be changed in accordance with a purpose, a use or a like.

What is claimed is:

1. A color liquid crystal display in which a liquid crystal is put between a TFT substrate and an opposite substrate, said color liquid crystal display comprising:
a shading film including a first filter formed from one of a red resist film and a blue resist film and a second filter formed from another of said red resist film and said blue resist film and laminated on said first filter and being formed in said TFT substrate; and
a color filter including said red resist film and said blue resist film.

2. The color liquid crystal display according to claim 1, wherein said shading film is formed to cover a surface of a liquid crystal driving element formed in said TFT substrate.

3. A color liquid crystal display in which a liquid crystal is put between a TFT substrate and an opposite substrate, said color liquid crystal display comprising:
a shading film including a first filter formed from one of a red resist film and a blue resist film, a second filter formed from another of said red resist film and said blue resist film and laminated on said first filter and a third filter formed from a green resist film and laminated on said second filter over said first filter and being formed in said TFT substrate; and
a color filter including said red resist film, said blue resist film and said green resist film.

4. The color liquid crystal display according to claim 3, wherein said shading film is formed to cover a surface of a liquid crystal driving element formed in said TFT substrate.

5. The color liquid crystal display according to claim 3, wherein said third filter is thinnest among said first filter, said second filter and said third filter forming said shading film.

6. The color liquid crystal display according to claim 4, wherein said third filter is thinnest among said first filter, said second filter and said third filter forming said shading film.

7. The color liquid crystal display according to claim 3, wherein said first filter, said second filter and said third filter are formed from pigment-dispersed photosensitive resist.

8. The color liquid crystal display according to claim 5, wherein said first filter, said second filter and said third filter are formed from pigment-dispersed photosensitive resist.

9. The color liquid crystal display according to claim 6, wherein said first filter, said second filter and said third filter are formed from pigment-dispersed photosensitive resist.

10. A method of manufacturing a color liquid crystal display in which a liquid crystal is put between a TFT substrate and an opposite substrate and a color filter and a shading film including plural unit filters are laminated on said TFT substrate; said method comprising;
a step of forming plural liquid crystal driving elements on said TFT substrate;
a step of sequentially forming said plural unit filters on surfaces of said liquid crystal driving elements; and
a step of forming a green filter at last.

11. The method of manufacturing the color liquid crystal display according to claim 10, wherein as said red filter, said blue filter and said green filter; red-pigment dispersed photosensitive resist, blue-pigment dispersed photosensitive resist, green-pigment dispersed photosensitive resist are respectively used.

12. A method of manufacturing a color liquid crystal display in which a liquid crystal is put between a TFT substrate and an opposite substrate and a color filter and a shading film including plural unit filters are laminated on said TFT substrate; said method comprising;
a liquid crystal driving element forming step of forming plural liquid crystal driving elements on said TFT substrate;
a first filter forming step of forming a first filter formed from one of a red filter and a blue filter on an insulating protective film after covering said liquid crystal driving elements with said insulating protective film;
a first patterning step of patterning said first filter so as to be left at a first pixel position and surfaces of said liquid crystal driving elements;
a second filter forming step of forming a second filter formed from another of said red filter and said blue filter on a whole surface including said first filter;
a second patterning step of patterning said second filter so as to be left at a second pixel position and on said first filter;
a third filter forming step of forming a third filter formed from a green filter on a whole surface including said first filter and said second filter; and
a third patterning step of patterning said third filter so as to be left at a third pixel position and on said second filter.

13. The method of manufacturing the color liquid crystal display according to claim 12, further comprising:
a flatting film through hole forming step of forming a flatting film on a whole surface including said third filter and of forming a through hole making an electrode of said liquid crystal driving element exposed by patterning said flatting film successively in said third patterning step.

14. The method of manufacturing the color liquid crystal display according to claim 13, further comprising:
a pixel electrode forming step of forming a pixel electrode for connecting said through hole to said electrode successively in said flatting film through hole forming step.

15. The method of manufacturing the color liquid crystal display according to claim 12, wherein as said red filter, said blue filter and said green filter; red-pigment dispersed photosensitive resist, blue-pigment dispersed photosensitive resist, green-pigment dispersed photosensitive resist are respectively used.
